(19) United States
(12) Patent Application Publication
(10) Pub. No.: US 2017/0343819 A1
(43) Pub. Date: Nov. 30, 2017

(54) DISPLAY DEVICE WHICH CAN BE PLACED ON THE HEAD OF A USER

(71) Applicant: Carl Zeiss AG, Oberkochen (DE)

(72) Inventors: Scott LERNER, Venice, CA (US); Dietmar GAENGLER, Langenau (DE); Norbert KERWIEN, Moegglingen (DE); Wilhelm ULRICH, Aalen (DE)

(21) Appl. No.: 15/529,083

(22) PCT Filed: Nov. 24, 2015
(86) PCT No.: PCT/EP2015/075882

§ 371 Date: May 23, 2017

(30) Foreign Application Priority Data
Nov. 24, 2014 (DE) 10 2014 017 534.0

(51) Int. Cl. G02B 27/01; G02B 13/18; G06T 19/00; G02B 25/00

(52) U.S. Cl. CPC G02B 27/0172; G02B 13/18; G06T 19/006; G02B 25/001

(57) ABSTRACT

There is provided a display device with a holder that can be fitted on the head of a user and a first imaging optical system secured to the holder, which is formed to image an image generated in an image plane as a virtual image in such a way that, when the holder is fitted on his head, the user can perceive it with a first eye, wherein the first imaging optical system includes, as imaging element, precisely one first lens with a first and a second boundary surface, wherein the two boundary surfaces are each aspherically curved.

### PRIORITY

This application claims the benefit of German Patent Application No. 102014017534.0 filed on Nov. 24, 2014, which is hereby incorporated herein by reference in its entirety.

### FIELD

The present invention relates to a display device with a holder that can be fitted on the head of a user and a first imaging optical system connected mechanically to the holder, which is formed to image an image generated in an image plane as a virtual image in such a way that, when the holder is fitted on his head, the user can perceive it with a first eye.

### BACKGROUND

Display devices can be formed in particular in such a way that the user can only perceive the images generated by the display device and can no longer perceive the surroundings. Such display devices are also referred to as HMD devices (Head Mounted Display devices) or as VR spectacles (Virtual Reality spectacles). Since the user can only perceive the images generated by the display device and can no longer perceive the surroundings, he is submerged as it were in a virtual reality, which leaves a strong impression.

Such display devices should, since they are worn on the head, be as light as possible and, at the same time, as good as possible an imaging of the virtual image should be provided with a large field of view, which leads to the first imaging optical system having an increased weight since, for this purpose, it comprises e.g. several lenses.

### SUMMARY

The disclosure includes a display device with a holder that can be placed on the head of a user and a first imaging optical system connected mechanically to the holder, which is formed to image an image generated in an image plane as a virtual image in such a way that, when the holder is placed on his head, the user can perceive it with a first eye, in such a way that the difficulties named at the start can be overcome as completely as possible.

The disclosure also includes a display device which comprises a holder that can be placed on the head of a user and a first imaging optical system connected mechanically to the holder, which is formed to image an image generated in an image plane as a virtual image in such a way that, when the holder is placed on his head, the user can perceive it with a first eye, wherein the first imaging optical system comprises as imaging element precisely one first lens with a first and a second boundary surface, wherein both boundary surfaces are in each case aspherically curved.

It is thus possible to provide a sufficiently good imaging with only a single lens. Since the first imaging optical system comprises precisely one first lens (and no further imaging optical elements), the weight of the display device can be kept low.

The first and second boundary surfaces preferably have different spherical curvatures. In particular, the ratio of the value of the vertex curvature of the first boundary surface, which is facing the image plane, to the value of the vertex curvature of the second boundary surface can be in the range of from 1.2 to 1.8. It is thus possible to adequately correct the astigmatism, whereby the desired imaging quality can be provided.

In particular, the second boundary surface can be formed as a hyperboloid without higher-order deformations and/or the first boundary surface can be formed as a hyperboloid with higher-order deformations.

The first imaging optical system can be free from deflecting elements for beam path folding.

The first lens can be formed from plastic. This leads to a low weight. It can be formed from PMMA for example. This leads to a reduction in the undesired chromatic aberrations since PMMA has a low dispersion.

Furthermore, a diaphragm can be positioned in front of the first boundary surface and thus between the first boundary surface and the image plane. Beams with a strong aberration, which would otherwise be directed from the first lens in an undesired way to the exit pupil of the first imaging optical system, can thus be shadowed.

The distance between the second boundary surface and the exit pupil of the first imaging optical system can be in the range of from 5 to 25 mm, in particular in the range of from 13 to 20 mm.

The field of view provided can have a value between 65° and 105° in the diagonal direction.

The distance between the exit pupil of the first imaging optical system and the image plane can be in the range of from 50 to 70 mm.

The exit pupil of the first imaging optical system can have a maximum size of greater than or equal to 3 mm, preferably of greater than or equal to 5 mm.

The display device can be designed in such a way that the image generated in the image plane has a diagonal of 50 mm or less.

The first imaging optical system can be designed in such a way that the astigmatism can be regarded as corrected, whereas a distortion and a lateral chromatic aberration are allowed. The image generated in the image plane is then preferably generated with a corresponding opposite distortion and a corresponding opposite lateral chromatic aberration with the result that the imaged virtual image is imaged without distortion or with little distortion and without chromatic aberration or with little lateral chromatic aberration.

Furthermore, the first imaging optical system can be optimized in such a way that the field curvature still present can be compensated by accommodation by means of the eye.

In particular, the aspherically curved boundary surfaces are formed in such a way that they correct the spherical aberration. Preferably they can also correct higher-order aberrations. In addition, the first imaging optical system can be designed in such a way that its Petzval radius is in the range of from −55 to −49.

Furthermore, the first imaging optical system can be designed in such a way that, during imaging, the angular deviation of the beams caused by the first boundary surface is compensated by the angular deviation of the beams caused by the second boundary surface. By this is meant in particular that |nₐᵢᵣ*sin β₁−n_{substrate}*sin β₂+nₐᵢᵣ*sin β₃−n_{substrate}*sin β₂| is zero or almost zero, wherein the angles sin β₁, sin β₂ and sin β₃ are in each case the angle following the exit pupil 22, the first boundary surface 20 and the second boundary surface 21 of a main beam from the edge of the field or image to be imaged with the optical axis or an axis shifted in parallel with respect to the optical axis, and nₐᵢᵣ and n_{substrate} are the indices of refraction of the surrounding medium in each case. The absolute value of this term is preferably less than 0.1, in particular less than 0.7, less than 0.5 or less than 0.01.

The display device can furthermore comprise an image module connected mechanically to the holder, which comprises a screen, on which the image is generated in the image plane. The image module can comprise a control unit for actuating the screen and a sensor unit for detecting a movement of the image module. The sensor unit can be equipped to supply signals to the control unit. The control unit can be equipped to recognize from the signals a tipping of the holder which has been carried out and to bring about, in dependence on the recognized tipping, a change in the image generated on the screen and/or the control of an application executed on the image module which provides contents which are contained in the image generated on the screen.

Such a tipping or striking of the holder can be carried out discreetly and also in noisy surroundings without the input being distorted thereby. The display device can thus be controlled discreetly and securely.

An input can thus be carried out by tipping, striking or knocking against the holder. The holder per se is used as an input interface which is sensitive to the holder being touched (in particular tipping, striking or knocking against the holder), wherein the holder does not need to be specifically adapted for this. The holder can be used as an input interface as it is since the measurement of the interaction (the tipping, striking or knocking etc.) carried out with the holder takes place by means of the sensor unit and the evaluation of the measurement signals takes place by means of the control unit, which are both part of the image module.

The control unit can recognize from the supplied signals the position of the tipping which has been carried out on the holder, the strength of the tipping of the holder which has been carried out, the time interval between at least two successive tipping events and/or recognize the direction in which the holder was struck or knocked against during the tipping, and, in dependence on the recognized position, the recognized strength of the tipping, the recognized time interval and/or the recognized direction, can bring about a change in the image generated on the screen and/or control the application.

The control unit can recognize from the signals a spatial and/or time pattern of one or more tipping events and, in dependence thereon, can bring about a change in the image generated on the screen and/or control the application. The spatial and/or time pattern is thus converted into a control command.

A selectable menu option can be represented in the image on the left-hand and on the right-hand side of the screen, which can be selected by tipping the associated left-hand or right-hand side of the holder. It is also possible for the display device to represent a selectable menu option at least in one corner of the generated image, which can be selected by tipping the holder in the area of this corner.

The display device according can be formed as an HMD device and/or as VR spectacles.

The image module can be replaceably connected to the holder.

The holder can comprise a front part in which the image module and the first imaging optical system are arranged, wherein, when the holder is fitted on the head, the front part is preferably positioned in front of the user's eyes in such a way that the user can only perceive the virtual image and not the surroundings. In particular, the front part can lie against the face in a light-proof manner in an area surrounding the eyes.

When the holder is fitted on the head, the screen of the image module can be essentially perpendicular to the direction of forward view. By this is meant in particular that the angle between the direction of forward view and the screen is 90° or almost 90° (for example with a maximum deviation ≦10° in both directions and thus the angle can have values of from 80° to 100° or preferably with a maximum deviation 5° in both directions and thus the angle can have values of from 85° to 95°).

The display device can comprise a second imaging optical system, which can be formed in the same way as the first imaging optical system. The second imaging optical system is in particular formed to provide a second image generated on the screen as a virtual image, when the user wears the holder on his head. In particular, the first imaging optical system can provide the virtual image for a first eye and the second imaging optical system can provide the virtual image for the second eye. In this case, a binocular display device is provided. The first and/or second imaging optical system can be formed as a magnifying optical system.

The distance between the optical axes of the first imaging optical system and of the second imaging optical system is preferably between 60 and 65 mm, in particular between 61 and 63 mm.

It can be provided that the distance between the imaging optical systems can be set to a desired distance which can correspond to the distance between the user's eyes.

The sensor unit can comprise an inertia sensor, such as e.g. a gyroscope, a tilt sensor, an acceleration sensor and/or another type of sensor.

The mechanical connection of the image module to the holder is preferably without play.

The application executed on the image module can actuate the screen in such a way that, on the basis of the supplied image data of a first image, the first image is generated both in a first section of the screen and also in a second section of the screen separate from the first section.

The application is executed directly on the image module, so the desired image generation can advantageously be carried out rapidly. In addition, image data which are saved in the image module or have been generated by the latter can be used for the representation.

The image module can be a portable device with a control unit for executing program instructions and for actuating the screen. Such a portable device is e.g. a mobile phone, such as e.g. a smartphone.

The property of the portable image module of being able to execute program instructions is thus used in order to execute the application on the image module with the corresponding instructions, which application carries out the actuation of the screen and preferably the division of the screen into two sections with the representation of the same image in both sections.

The application can actuate the screen in such a way that the two sections are spaced apart from each other and the area between the two sections is switched to dark.

Furthermore, the application can generate the first image in the first and second sections in such a way that there is no stereo effect when looking at the two images. Of course, the images can also be generated in such a way that there is a stereo effect.

The image data can be supplied in such a way that the application accesses image data saved in the image module (also called image-generating device below) and/or that the image data are streamed onto the image-generating device and/or that the image data are generated on the image-generating device. In particular, the application can represent image data of other applications on the image-generating device according to the invention.

Furthermore, it is possible for the first image to be generated pre-distorted in at least one of the sections and thereby for an imaging error of the imaging optical system to be at least partially compensated.

Of course, it is also possible for the captured surroundings to be subjected to a further image data processing before they are represented. This can be a brightness adjustment, a colour adjustment, a false-colour representation, etc.

When the portable image-generating device is formed e.g. as a mobile phone, the application can also be referred to as an app.

The attached image data can in particular be image data of a capture of the surroundings of a user wearing the display device on his head and/or another type of image data. It is thus possible, for example, to show the user the surroundings as the first image. In addition, the surroundings can be shown with further items of image information superimposed with the result that more than the surroundings is displayed to the user. These can, for example, be information which is generated depending on the context and is represented in the generated image.

In particular, a live image of the surroundings can be displayed to the user. For this purpose, another camera is preferably provided which captures the surroundings. The camera can be a separate camera which is preferably secured to the display device (e.g. to the holder). In particular it is possible to use a camera which is available on the image-generating device. In the case of smartphones, as a rule a camera is provided which is provided on the rear side (the side facing away from the screen) with the result that this camera can be used to capture the surroundings.

The described representation of the surroundings superimposed with a further item of image information is also often referred to as Augmented Reality representation.

The application can generate the first image in the first and second sections in such a way that image content of the first image is generated in the first and second sections either with a first spacing or with a second spacing which is different therefrom. It is thus possible to adapt the image generation to users' different interpupillary distances.

In particular, the application can comprise an interface via which the spacing can be input, wherein the first image is then generated in the first and second sections in dependence on the input spacing in such a way that the input spacing is present on the screen between the image content of the image. The interface can, in particular, be the input interface according to the invention of the holder, which can be operated by tipping, knocking or striking. In particular, it is possible to change the spacing continuously by means of the application.

In order to adjust the spacing, it may be necessary to crop the first image. The complete first image is thus not then represented in the two sections but only a cropped first image.

Any areas of the screen not filled by the first image can be represented black.

The front part of the display device can comprise a receptacle into which the image module can be replaceably inserted.

The receptacle can comprise a mount which is adapted to the image module and can be reversibly separated from the receptacle, into which mount the image module can be inserted. Advantageously, a simplified separation of the image module from the display device is thus achieved in that the image module itself is not removed but rather the image module together with the mount. Advantageously, when separated from the display device, the mount can thus also be used as a permanent protective cover for the portable image module for protection against mechanical damage.

The mount is adapted to the portable image module and/or the receptacle in such a way that, when the mount is secured to the holder, the image module is automatically positioned in the image plane. For example, the mount can be individually adapted to hold a predetermined product of image module, in particular a predetermined model of a mobile phone in such a way that, when the mount is secured to the receptacle, the image module is automatically positioned in the image plane. Advantageously, different image modules can thus be combined with the display device in a simple manner.

Preferably, the mount can comprise a recess complementary to the external dimensions of the image module, in which the image module can be embedded fitting precisely in such a way that an image-generating front side of the image module (i.e. the screen side in the case of a mobile phone) remains essentially uncovered by the mount.

In particular, the mount is adapted to the receptacle.

Inserting the mount into the receptacle can comprise, in particular, sliding in and/or snapping in.

The mount can comprise at least one holding element which holds the image module in such a way that it can be removed when it is inserted in the mount. Preferably, the holding element can be formed by a flanged edge which at least partially engages around an outer edge of the image-generating front side of the image module.

The mount can comprise a frame. The frame can have internal dimensions for the (precisely fitting) insertion of the image module and external dimensions for (precisely fitting) insertion into the holder.

The frame can comprise a cover on the rear side which forms a lower flat closure of the frame and can therefore also be referred to as the frame base.

The rear-side cover can comprise an optically transparent partial area. The optically transparent partial area of the cover can comprise an opening or an optically transparent material, for example a transparent plastic.

The optically transparent partial area is preferably provided in the area of the frame base which is opposite a rear-side camera of the image module. It is thus made possible in particular to access a camera of the image module even when the image module is inserted. For example, it is conceivable for the camera of a mobile phone or of any other image module equipped with a camera to capture images (of the surroundings) while the user is wearing the display device with the image module inserted on his head.

Within the framework of the present description, by an optically transparent material is meant a material which is (partially) transparent to visible light, wherein the degree of transparency can be chosen freely and, in particular, can be in the range between 100% and 60%.

The optically transparent material can comprise an optically effective layer. For example, a partially reflective layer can be provided, the reflectivity of which can be chosen freely, but can preferably be between 5 and 30%. Alternatively, it is possible for the partial area to be left open as an opening in the frame base.

On the front side, the frame can comprise a non-transparent central bar which separates the image-generating front side of the image module inserted into the frame into a first optically accessible area and a second optically accessible area.

Advantageously, the mount can comprise an insert which is adapted to the image module and can be separated from the mount. By adapting the insert individually to the imaging system it is made possible to provide a single mount for different imaging systems.

The insert can in turn be designed as a frame adapted to the image module, which frame can in turn further comprise a frame base with the features already explained above.

Advantageously, the mount can be inserted in the receptacle by sliding in. In this way, a particularly user-friendly way of connecting the image module to the mount is provided.

The receptacle can comprise a first slot with the result that the mount can be slid into the receptacle for example from the side or from the top, in the same way as a drawer.

It can be provided that a further slot is provided opposite the first slot via which the mount can be removed from the receptacle again, or vice versa.

Advantageously, the receptacle can comprise a guide along which the mount can be slid into the receptacle. The guide is preferably arranged on a narrow side of the receptacle. For example, the guide can comprise a guide bar. The guide can comprise a detent with a locking position. The detent can advantageously realize the second positioning device. The imaging system can thus be automatically aligned relative to an optical axis of the first imaging optical system in a simple manner. The detent can be realized by a spring element secured to the front part, which engages for example in a recess in the mount, provided for this purpose.

In particular, the receptacle can be formed at the front end (i.e. the end facing away from the user) of the front part with the result that the inserted image module or in the case of embodiment examples the frame base forms the front closure of the display device. The display device can thus be designed particularly compact. In particular, when the image module is slid into the receptacle like a drawer, in particular in the cases together with a mount, the receptacle can also be formed spaced apart from the front end of the display device. In this case, an optically transparent partial area can be arranged at the front end of the display device. The optically transparent partial area of the front end can be made from an optically transparent material, for example a transparent plastic. The optically transparent material can comprise an optically effective layer. For example, a partially reflective layer can be provided, the reflectivity of which can be chosen freely, but can preferably be between 5 and 30%. Alternatively, it is possible for the partial area to be left open as an opening in the cover. The optically transparent partial area is preferably provided in the region of a rear-side camera of the image module, whereby advantageously the access to the camera already described above is also made possible when the imaging system is inserted.

It is understood that the features named above and those yet to be explained below can be used not only in the stated combinations but also in other combinations or alone without departing from the scope of the present invention.

### BRIEF DESCRIPTION OF THE DRAWINGS

FIG. 1 is a schematic perspective representation of an embodiment of the display device.

FIG. 2 is a schematic top view of the embodiment from FIG. 1.

FIG. 3 is a schematic top view of the image-generating device arranged in the display device.

FIG. 4 is a top view of the image-generating device according to FIG. 3 to explain the division of the screen into two sections and the representation of the same images in both sections.

FIG. 5 is a sectional representation through the first imaging optical system according to FIG. 2.

FIG. 6 is a representation to explain the field of view S provided.

FIG. 7 is diagrams of the beam aberrations for different field points for the y- and x-direction for the three wavelengths 656.27 nm (curves W1), 587.56 nm (curves W2) and 486.13 nm (curves W3).

FIG. 8 is diagrams which show the longitudinal spherical aberration, astigmatic field curves and the distortion.

FIG. 9 is diagrams of the beam aberrations of a second embodiment of the first imaging optical system for different field points for the y- and x-direction for the three wavelengths 656.27 nm (curves W1), 587.56 nm (curves W2) and 486.13 nm (curves W3).

FIG. 10 is diagrams which show the longitudinal spherical aberration, astigmatic field curves and the distortion for the second embodiment of the first imaging optical system.

FIG. 11 is diagrams of the beam aberrations of a third embodiment of the first imaging optical system for different field points for the y- and x-direction for the three wavelengths 656.27 nm (curves W1), 587.56 nm (curves W2) and 486.13 nm (curves W3).

FIG. 12 is diagrams which show the longitudinal spherical aberration, astigmatic field curves and the distortion of the third embodiment of the first imaging optical system.

FIG. 13 is diagrams of the beam aberrations of a fourth embodiment of the first imaging optical system for different field points for the y- and x-direction for the three wavelengths 656.27 nm (curves W1), 587.56 nm (curves W2) and 486.13 nm (curves W3).

FIG. 14 is diagrams which show the longitudinal spherical aberration, astigmatic field curves and the distortion of the fourth embodiment of the first imaging optical system.

FIG. 15 is diagrams of the beam aberrations of a fifth embodiment of the first imaging optical system for different field points for the y- and x-direction for the three wavelengths 656.27 nm (curves W1), 587.56 nm (curves W2) and 486.13 nm (curves W3).

FIG. 16 is diagrams which show the longitudinal spherical aberration, astigmatic field curves and the distortion of the fifth embodiment of the first imaging optical system.

FIG. 17 is diagrams of the beam aberrations of a sixth embodiment of the first imaging optical system for different field points for the y- and x-direction for the three wavelengths 656.27 nm (curves W1), 587.56 nm (curves W2) and 486.13 nm (curves W3).

FIG. 18 is diagrams which show the longitudinal spherical aberration, astigmatic field curves and the distortion of the sixth embodiment of the first imaging optical system.

FIG. 19 is diagrams of the beam aberrations of a seventh embodiment of the first imaging optical system for different field points for the y- and x-direction for the three wavelengths 656.27 nm (curves W1), 587.56 nm (curves W2) and 486.13 nm (curves W3).

FIG. 20 is diagrams which show the longitudinal spherical aberration, astigmatic field curves and the distortion of the seventh embodiment of the first imaging optical system.

FIG. 21 is diagrams of the beam aberrations of an eighth embodiment of the first imaging optical system for different field points for the y- and x-direction for the three wavelengths 656.27 nm (curves W1), 587.56 nm (curves W2) and 486.13 nm (curves W3).

FIG. 22 is diagrams which show the longitudinal spherical aberration, astigmatic field curves and the distortion of the eighth embodiment of the first imaging optical system.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

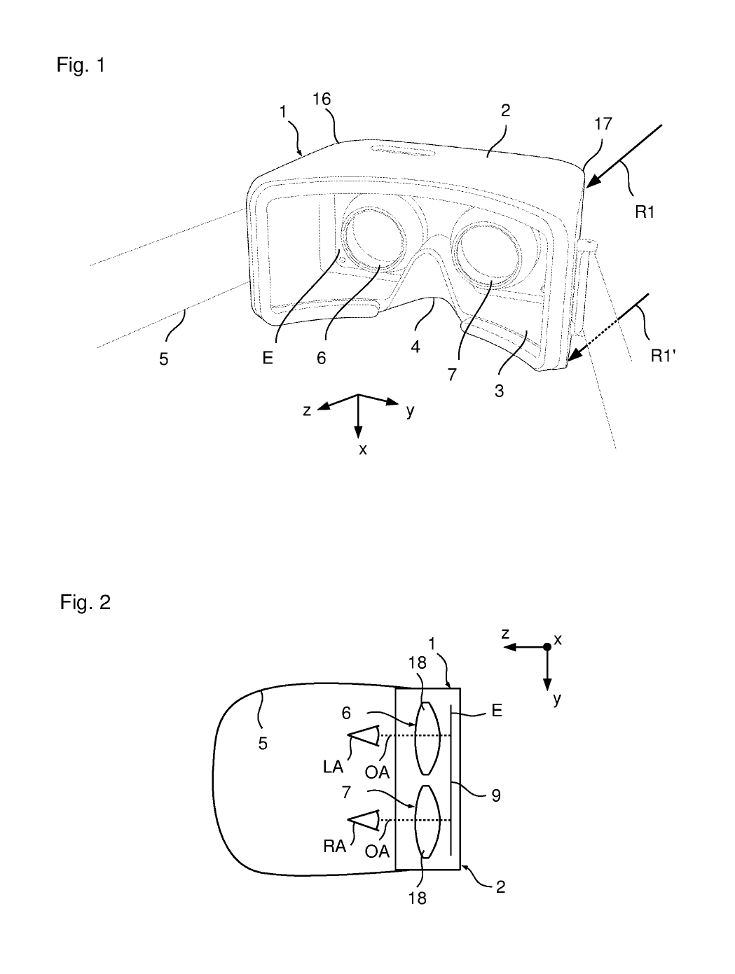

In FIG. 1 a first embodiment of the display device 1 according to the invention is shown schematically in a perspective representation. The display device 1 comprises a front part 2 formed essentially box-shaped with an open side 3. All the other sides of the front part are at least essentially closed. The contour of the open side 3 is formed in such a way that it can be placed on the head of a user in such a way that the user can wear the display device 1 on his head like a pair of spectacles. For this purpose, the contour has a nose pad 4 on one side and, on the two lateral ends of the front part 2, a retaining strap 5 is secured. When the display device 1 according to the invention is worn, the retaining strap 5 is guided around the head of the user in such a way that the desired contact pressure is present, with the result that the display device 1 can be worn on the head ergonomically and preferably in a light-proof manner. The retaining strap 5 can be formed e.g. as an elastic strap and/or as a strap with an adjustable length. Together with the retaining strap 5, the front part 2 forms a holder that can be fitted on the head of the user.

The display device 1 according to the invention comprises a first imaging optical system 6 for a left eye LA of the user and a second imaging optical system 7 for a right eye RA of the user, which in each case image an image generated in an image plane E enlarged in such a way that the user can perceive it as a virtual image. This can best be seen in FIG. 2, which shows a schematic top view of the display device 1 according to the invention, wherein, for a better representation, in FIG. 2 the front part 2 is shown to be open at the top, which is not actually the case however.

The front part 2 is formed essentially closed except for the side 3. In a preferred embodiment, these sides are completely closed, which seals off light from the outside. In another preferred embodiment, ventilation slots and/or ventilation holes are introduced into these sides, which are particularly preferably designed in such a way that the light passing through them from the outside is minimized.

Since the front part 2 is formed essentially closed except for the side 3, when he is wearing the display device 1 on his head as intended, the user can only perceive the images generated in the image plane E and can no longer perceive the surroundings.

For image generation, the display device according to the invention can comprise a portable image module 8 with a screen 9, which is arranged in the display device 1 in such a way that the screen 9 of the portable device 8 lies in the image plane E. In FIG. 2, to simplify the representation, only the screen 9 is drawn in schematically and, in FIG. 1, to simplify the representation, only the image plane E is represented and not the device 8. For the rapid exchange of the portable image module 8, a mount is provided consisting of a frame with a frame base (not shown). A recess is provided in the frame base, which is opposite a rear-side camera of the portable image module 8. The frame can be slid sideways into a receptacle which is provided in the front part 2. Two sprung elements are present in the receptacle, which engage in a locking manner on a detent of the frame in such a way that, when the frame is slid into the receptacle, the correct seating of the frame in the receptacle is provided and the frame is replaceably fixed in this position. Alternatively, for this purpose, in each case two small permanent magnets or magnetizable small metal discs are provided in the receptacle at the top and the bottom as well as at the corresponding positions of the frame. The front flat closure of the front part 2 is formed by a partially transparent plastic disc. The disc has a partially reflective coating with the result that the inserted image module 8 cannot or can hardly be seen from the outside but a rear-side camera of the image module 8 can look outwards.

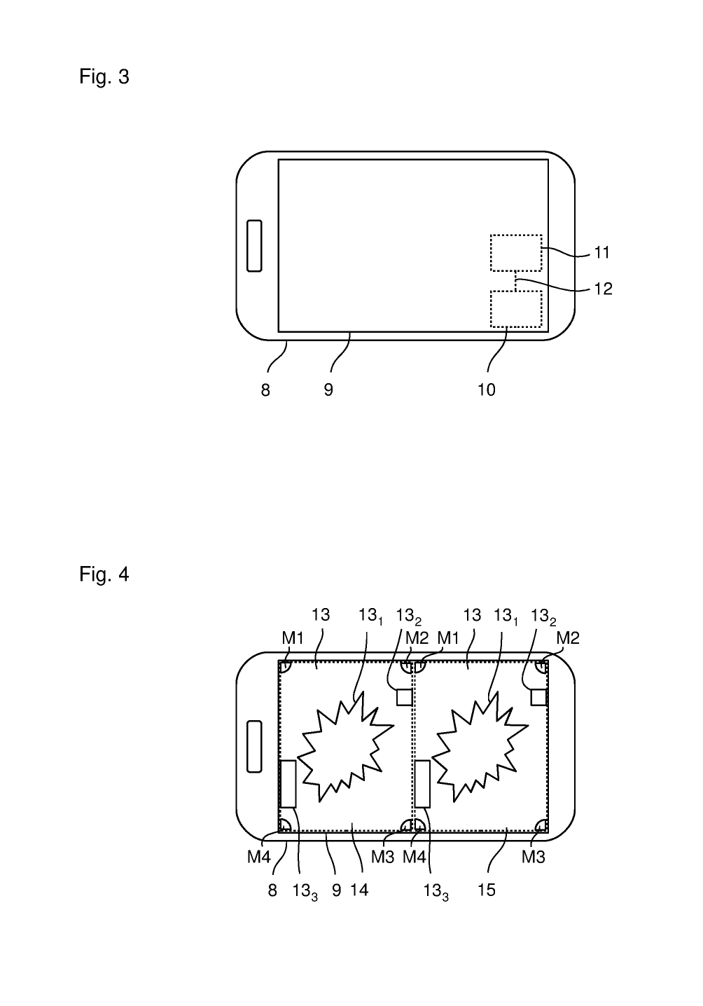

In FIG. 3 such a portable device 8 is represented by way of example, which comprises a screen 9, a control unit 10 as well as a sensor unit 11 for detecting a movement of the device 8. Further elements necessary for operating the device 8 are not shown. The control unit 10 and the sensor unit 11 are represented with dotted lines since they are built into the device 8 and are not normally visible from the outside.

The control unit 10 can execute program instructions and serves to actuate the screen 9.

The sensor unit 11 can comprise an inertia sensor, such as e.g. a single-axis, double-axis or triple-axis gyroscope, a tilt sensor, an acceleration sensor and/or another type of sensor with which it is possible to detect a movement of the device 8. The sensor unit 11 generates corresponding measurement signals which are transferred to the control unit 10 (preferably continuously), as is represented schematically in FIG. 3 by the dotted connecting line 12.

The portable device 8 can, for example, be a mobile phone (e.g. a so-called smartphone) or another type of device with a corresponding screen (such as e.g. the so-called iPod touch from Apple Inc., California, USA) and is preferably replaceably arranged in the front part 2.

As can be seen from the representation in FIG. 2, each of the two imaging optical systems 6, 7 only images a partial area of the screen 9. So that a user wearing the display device 1 on his head can perceive an object to be represented with both eyes, this object must thus be generated in both partial areas of the screen 9, which are imaged by the two imaging optical systems 6 and 7.

For this purpose, an application or a program is provided on the portable device 8, which is executed by the control unit 10 and actuates the screen 9 in such a way that, on the basis of the supplied image data for the object to be represented or for a first image to be represented, the object or the first image 13 with schematically represented image elements 13₁, 13₂ and 13₃ is generated both in a first section 14 of the screen 9 and also in a second section 15 of the screen separate from the first section 14, as is shown in FIG. 4.

Since the application is executed on the device 8 itself, image data saved in the device 8 or image data supplied to the device 8 (e.g. streamed image data, preferably via a suitable wireless connection) can advantageously be used in order to generate the representation of the images in the two sections 14 and 15. In particular, image data originating from other applications running on the device 8 can be processed by the application according to the invention in such a way that the same image is always represented in both sections 14 and 15. Images and films can thus be offered to the user wearing the display device 1 on his head in such a way that he can perceive them enlarged as virtual images with both eyes. The user can thus perceive e.g. videos from YouTube or other video platforms, videos which are saved on the device or other videos or images enlarged as desired. It is also possible to represent enlarged images from games or other applications installed on the device.

The two sections 14 and 15 can be chosen in such a way that they border each other directly. Alternatively, it is possible for them to be spaced apart from each other. The spacing area can, in particular, be represented or actuated as an area which is switched dark.

The application can represent the images 13 in the two sections 14, 15 in such a way that there is no stereo effect for the user. However, it is also possible to generate a stereo effect.

In the case of the portable device 8, the screen 9 is preferably touch-sensitive and forms the primary input interface. During use of the display device 1 as intended this primary input interface is no longer accessible to the user since the device is then inserted in the front part 2. The display device 1 according to the invention is therefore formed in such a way that tipping of the front part 2 is measured by means of the sensor unit 11 and is evaluated by means of the control unit 10, which can thereupon actuate the screen 9 in such a way that the first image 11 is changed. Tipping of the front part 2 can be detected easily by means of the device 8 since, when it is inserted in the front part 2, the device 8 is mechanically connected to the front part 2 (preferably free from play), so that it maintains the preset position relative to the imaging optical systems 6 and 7 during the intended use of the display device 1. Tipping of the front part 2 is thus transferred directly to the device 8 and can then be measured by means of the sensor unit 11. This leads to a change in the measurement signals generated by the sensor unit 11, which are transferred to the control unit 10 with the result that the control unit 10 can recognize a tipping which has been carried out in dependence on the change in the measurement signals.

The simplest input is thus a single tipping, which corresponds for example to clicking on a button with a mouse in a conventional computer.

The control unit 10 can thus be formed in particular in such a way that it recognizes tipping. The number of several tipping actions and/or the time spacing thereof can also be evaluated as input signals. In addition, it is possible for the position at which the front part 2 is tipped to be evaluated as a further item of information for the thus-provided input interface. Thus, for example, the application which has just been executed on the device 8 and the image 13 of which is represented can offer individual menu options or functions for selection in the four corners of the image, as is indicated by the quadrants M1, M2, M3 and M4 in FIG. 4. Tipping of the front part 2 in the upper left-hand area 16 (FIG. 1) then leads to the selection of the menu option M1. Tipping in the upper right-hand area 17 of the front part 2 (FIG. 1) then leads to the selection of the menu option M2. In the same way, tipping in the lower left-hand area of the front part 2 leads to the selection of the menu option M3 and tipping in the lower right-hand area of the front part 2 leads to the selection of the menu option M4.

Tipping of the front part 2 from different directions brings about, in particular when using a “multi-axis” sensor, a signal characteristic in each axis with the result that conclusions can be drawn about the location and/or the direction of tipping by analyzing the signals in the individual axes.

For example, if a user standing upright with his head raised is wearing the device, tipping the left-hand side brings about, for example, a positive signal in the horizontal sensor, for example, while tipping the right-hand side then brings about, for example, a negative signal in the horizontal sensor. In contrast, the vertical sensor shows no signal.

Tipping the upper right-hand corner in the direction of the bottom left brings about, for example, a negative signal in the horizontal sensor and, for example, a negative signal in the vertical sensor. Tipping the lower right-hand corner in the direction of the top left then brings about, for example, a negative signal in the horizontal sensor but a positive signal, for example, in the vertical sensor. And so on. In this way, the direction of the tipping can be determined. Since the shape of the front part 2 is known and tipping is in practice only possible from outside, it is thus also clear (at least approximately) which point of the front part 2 was tipped.

It is also possible to use the determined direction of tipping, i.e. the direction in which the front part 2 was struck during tipping, as an input criterion. Striking in a first direction R1 from top right to bottom left (FIG. 1) can e.g. be interpreted and processed as selection of the menu option M2. However, e.g. the position of tipping can be disregarded with the result that tipping in the same direction at another point of the front part 2, as is shown by the arrow R1′ in FIG. 1, would also lead to the selection of the menu option M2. Alternatively, the position of the tipping can additionally be taken into account, of course. Furthermore, e.g. the direction of the tipping can be taken into account together with the strength of the tipping and thus the tipping momentum or the momentum generated by the tipping or striking.

In order to achieve a clear assignment, for example, of menu options or other functionalities it is particularly advantageous—unlike in usual applications/programs—to place the menu options in the corners of the screen display, since here a clear assignment of the signals to the corresponding directions or tipped points is particularly easy.

By tipping or striking of the front part 2, which can take place easily with one finger or several fingers, the display provided or the images 13 provided by the device 8 can thus be influenced.

The display device according to the invention thus provides an easy-to-use and well-functioning input interface with which the device 8 can be operated.

The two imaging optical systems 6, 7 can be formed the same or different. In the embodiment described here they are formed the same with the result that only the first imaging optical system 6 is described in detail below.

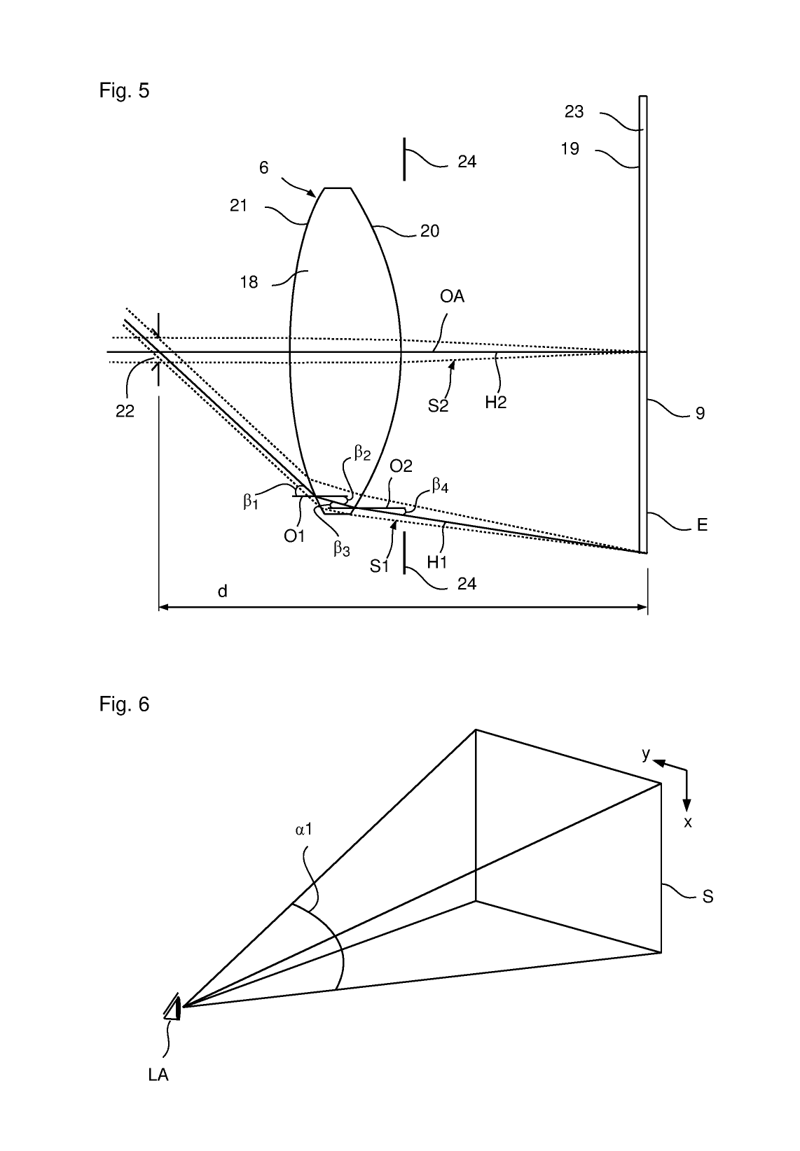

The first imaging optical system 6 comprises precisely one first lens 18, which is formed as a convex-convex lens made of plastic (e.g. PMMA) (FIG. 5).

The first lens 18 comprises a first and a second boundary surface 20, 21, wherein the first boundary surface 20 faces the screen 9 or the image plane E. In FIG. 6, the exit pupil 22 of the first imaging optical system 6, two bundles of rays S1 and S2 with corresponding main beams H1 and H2 as well as a glass cover 23 of the screen 9 are also shown, wherein the side of the glass cover 23 facing the first lens 18 is denoted by the reference number 19. Both boundary surfaces 20 and 21 are formed as aspherical surfaces. In particular they can be formed as rotationally symmetrical aspheres, which are rotationally symmetrical with respect to the optical axis OA. The optical axis OA is perpendicular to the image plane E.

The two boundary surfaces 20, 21 can be described by the following surface area equation, wherein r is the radial height on the surface, k is the conic constant and c indicates the curvature of the corresponding surface at the vertex. A, B and C are the fourth-, sixth- and eighth-order deformation coefficients:

$$z = \frac{{cr}^{2}}{1 + \sqrt{1 - ( 1 + k ) {c}^{2} {r}^{2}}} + {Ar}^{4} + {Br}^{6} + {Cr}^{8}$$

The aspherical constants for the surfaces 20 and 21 are indicated in the following Table 1.

TABLE 1

| Surface | c | k | A | B | C | D |
|---|---|---|---|---|---|---|
| 20 | −28.00 | −1.60 | 0 | 0.1900E−9 | 0 | 0 |
| 21 | 43.50 | −2.00 | 0 | 0 | 0 | 0 |

The distances along the optical axis OA are indicated in the following Table 2.

TABLE 2

| Surface-Surface | Distance [mm] |
|---|---|
| 22-21 | 16.0 |
| 21-20 | 14.2 |
| 20-19 | 29 |
| 19-E | 0.8 |

The first lens 18 is formed from PMMA with a first refractive index n1 of 1.492 and a first Abbe number ν1 of 57.2. Here, the refractive index and Abbe number are indicated for the wavelength of 589 nm.

The first imaging optical system 6 is designed in such a way that an astigmatism is corrected and that the field of view as well as the distance between the second boundary surface 21 and the exit pupil 22 is as large as possible. Distortion and lateral chromatic aberration are taken into account, however, since these are retained by the representation on the screen 9 in such a way that they are compensated as far as possible in the imaged virtual image. A distorted representation is thus carried out on the screen 9, which leads, after imaging by means of the first lens 18, to as undistorted as possible a virtual image. The same is carried out with the lateral chromatic aberration. For this, the application which is executed on the portable device 8 can be correspondingly formed. The application thus generates from the supplied image data those images 13 which, without looking through the first lens 18, are distorted and have a lateral chromatic aberration.

By forming the two boundary surfaces as aspherical surfaces, it is possible to correct spherical aberrations and higher-order aberrations.

Furthermore, the first imaging optical system 6 is designed in such a way that an angular deviation of the individual beams caused by the first boundary surface 20 is compensated (as far as possible) by the second boundary surface 21. This is the case when BGL is almost zero, wherein BGL is to be calculated as follows:

BGL=|nₐᵢᵣ*sin β₁−n_{substrate}*sin β₂+nₐᵢᵣ*sin β₃−n_{substrate}*sin β₂|.

Here, the angles β₁, β₂ and β₃ are the angle following the exit pupil 22 (β₁), the first boundary surface 20 (β₂) and the second boundary surface 21 (β₃) of a main beam H1 at the edge of the field or image 13 to be imaged with an axis O1 or O2 shifted in parallel with respect to the optical axis, as is drawn in schematically in FIG. 5, and nₐᵢᵣ and n_{substrate} are the indices of refraction of the surrounding medium in each case. In the embodiment example described here, BGL has a value of 0.00246. The value for BGL as well as for further parameters characterizing the first imaging optical system 6 are indicated in the following Table 3:

TABLE 3

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.00246 | 37.068 | −1.55 | −26.9 | −345.7 | 0.64 | −51.7 | 2.85 |

Here, K1 denotes the focal length, K2 the ratio of the vertex curvature of the first boundary surface 20 to the vertex curvature of the second boundary surface 21, K3 the distortion, K4 the lateral chromatic aberration, K5 the astigmatism, K6 the Petzval radius and K7 the defocusing.

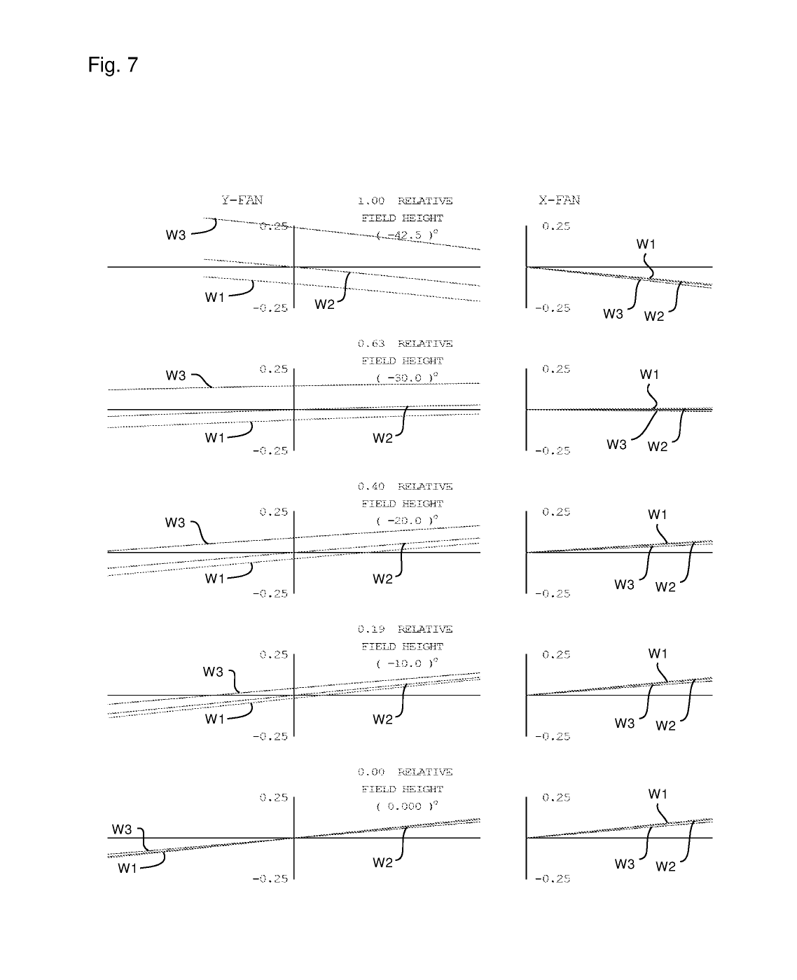

In FIG. 7, the beam aberrations are represented in mm in the known way for different field points for the y-direction and the x-direction for three different wavelengths. The curves for the wavelength 656.27 nm are denoted W1. The curves for the wavelength 587.56 nm are denoted W2 and the curves for the wavelength 486.13 nm are denoted W3. It can occur that the curves partially coincide in the representation.

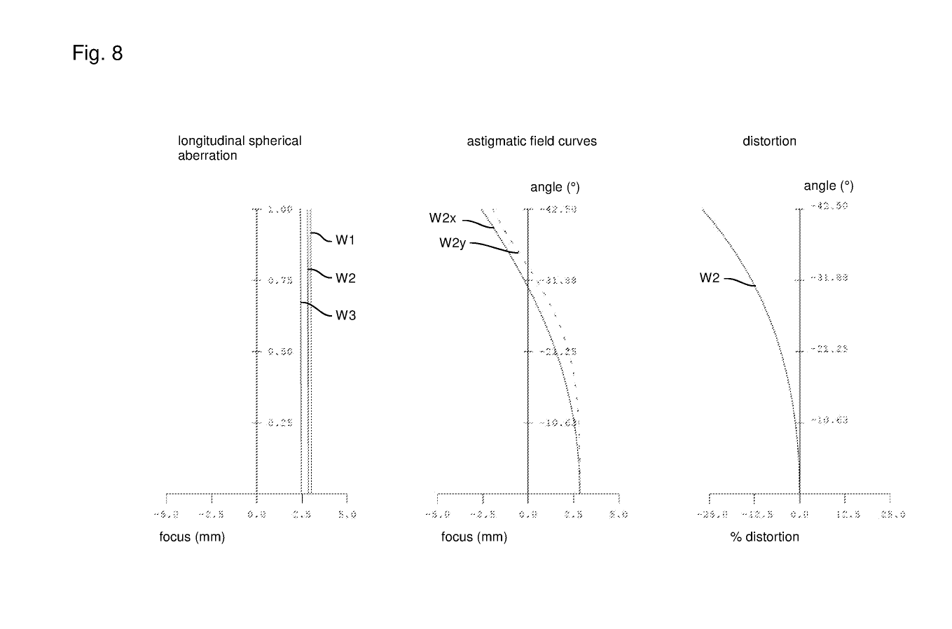

In FIG. 8, for the described embodiments, the longitudinal spherical aberration for the same wavelengths (curves W1, W2 and W3) as in FIG. 7, the astigmatic field curves in the x-direction (curve W2x) and in the y-direction (curve W2y) for the wavelength 587.56 nm as well as the distortion (curve W2) for the wavelength 587.56 nm are shown. The curves can partially coincide in FIG. 8 too. Further properties of the first imaging optical system 6 according to the described embodiment can be inferred from the representations in FIGS. 7 and 8.

With the first lens 18, it is possible to image the image 13 as a virtual image, wherein the exit pupil 22 (or the eyebox 22) of the first imaging optical system 6 has a diameter of 16 mm. The exit pupil 22 is spaced apart from the image plane E and thus from the screen 9 by a distance d of 60 mm.

The virtual image is provided for the user with a field of view S with α1=85° in the diagonal direction (FIG. 6).

Since the distance between the exit pupil 22 and the surface 21 is 16 mm, a person wearing spectacles can wear the display device 1 according to the invention as intended on his head together with his spectacles.

In the display device according to the invention, the two imaging optical systems 6 and 7 for the left and right eye LA, RA of the user are spaced apart from each other by 61 mm. This corresponds approximately to the average interpupillary distance of the world population.

As is shown in FIG. 5, a diaphragm 24 can be arranged in front of the first boundary surface 21 and thus between the first boundary surface 21 and the image plane E, which shadows beams with strong aberrations and so contributes to an improvement in the imaging.

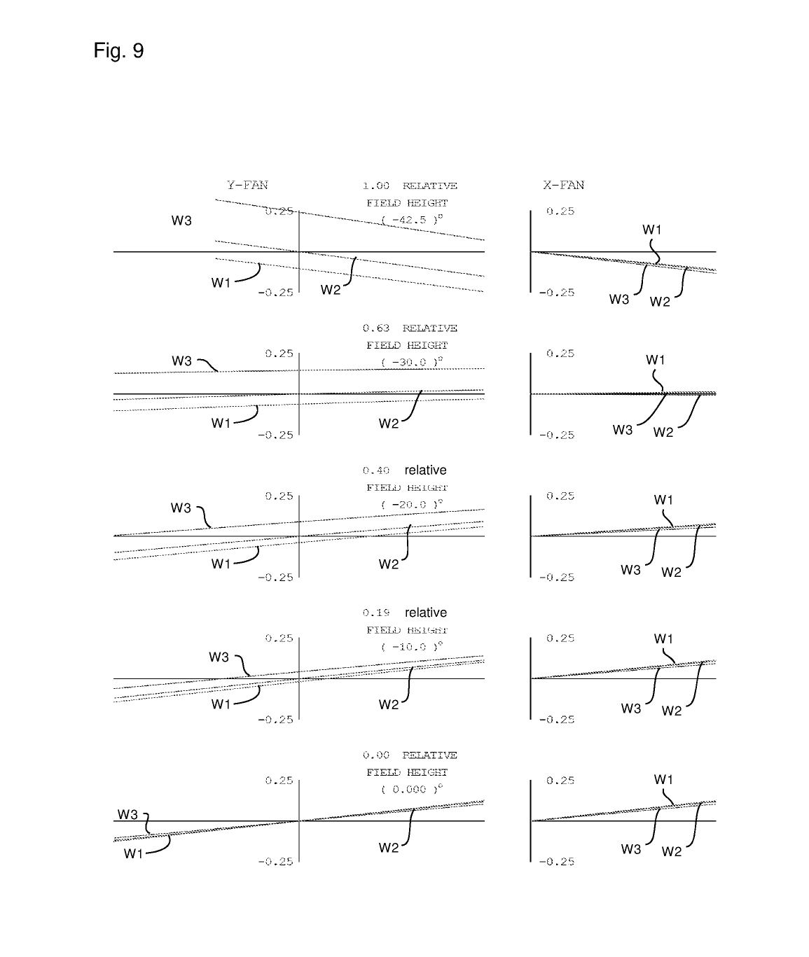

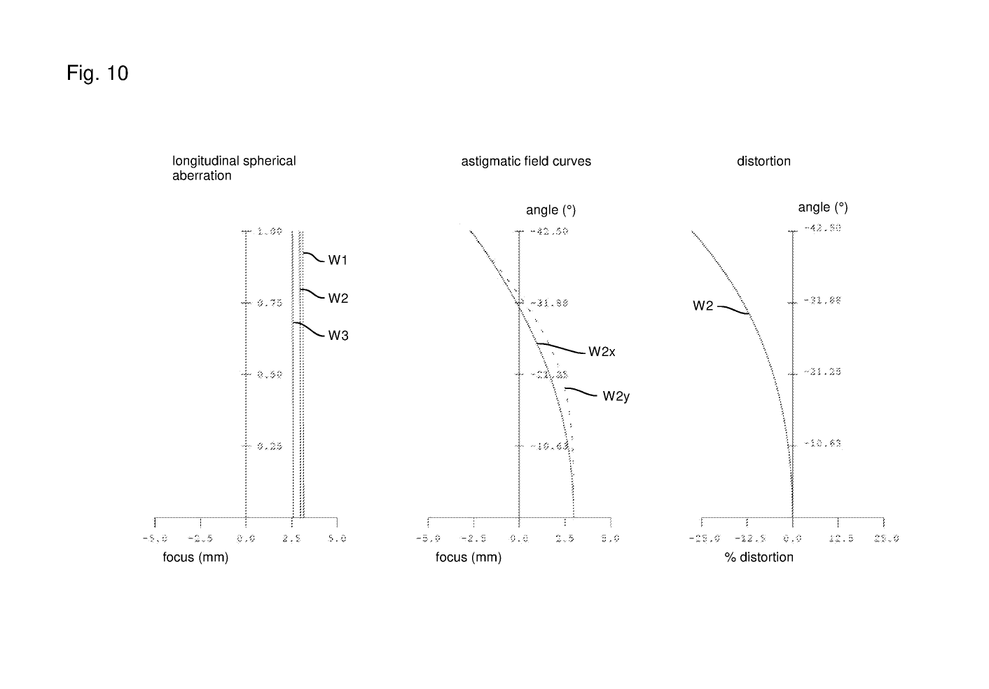

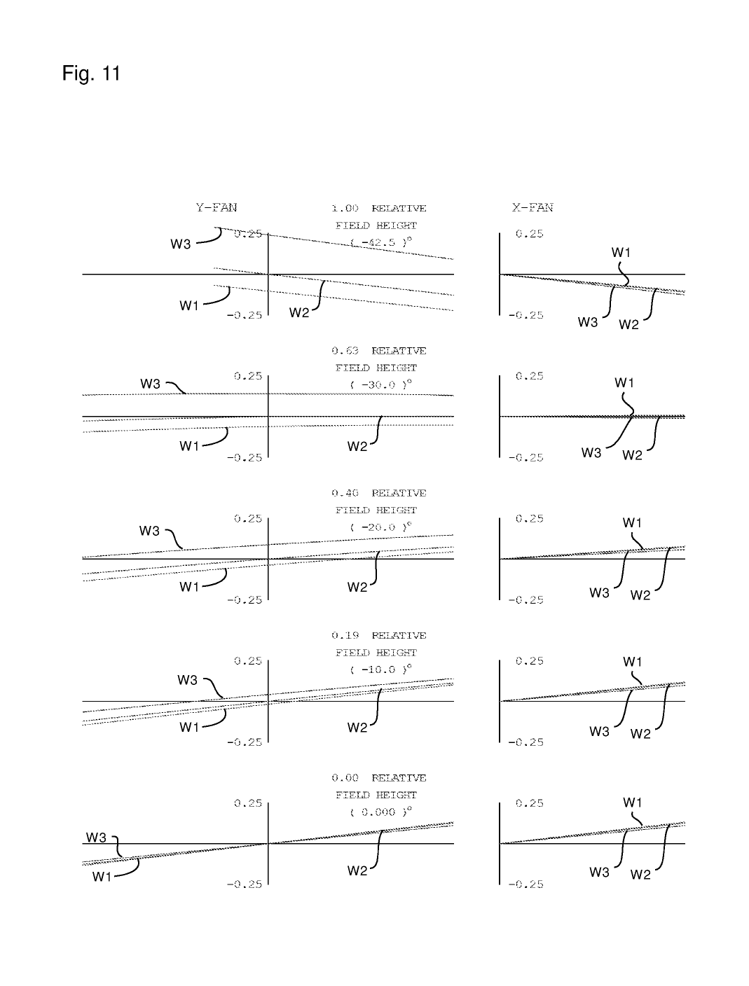

In FIGS. 9 and 10, the beam aberrations, the longitudinal spherical aberration, the astigmatic field curves and the distortion of a second embodiment of the first imaging optical system 6 are represented in the same way as in FIGS. 7 and 8. The aspherical constants for the surfaces 20 and 21 of the second embodiment are indicated in the following Table 4.

TABLE 4

| Surface | c | k | A | B | C | D |
|---|---|---|---|---|---|---|
| 20 | −28.56 | −1.65 | 0 | −0.1225E−9 | 0.8922E−12 | 0 |
| 21 | 42.84 | −2.08 | 0 | 0 | 0 | 0 |

The distances along the optical axis OA for the second embodiment are indicated in the following Table 5.

TABLE 5

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the second embodiment are indicated in the following Table 6:

TABLE 6

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.00033 | 37.297 | −1.50 | −27.6 | −346.1 | −0.05 | −52.0 | 2.98 |

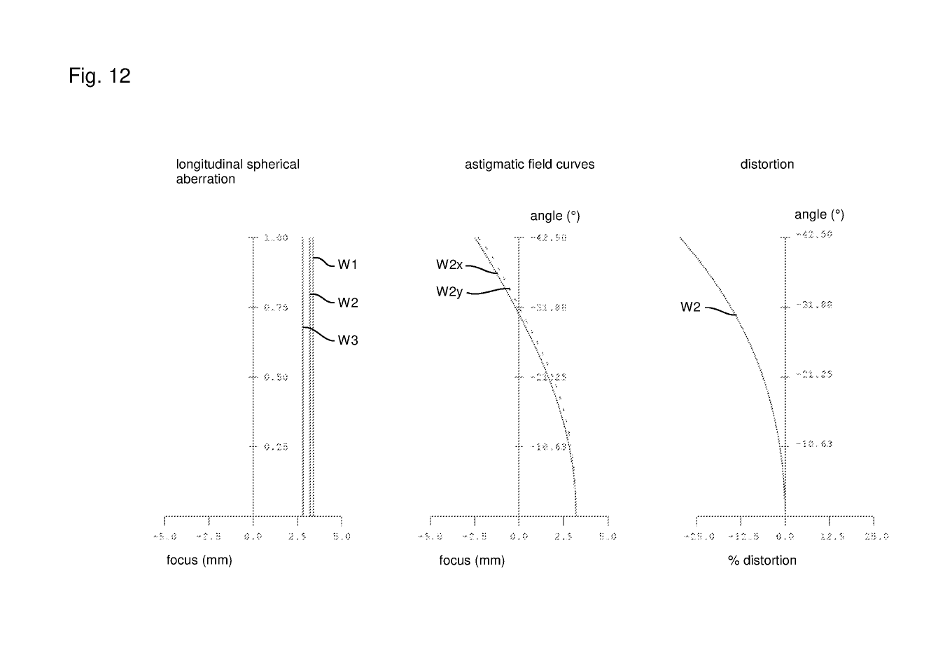

In FIGS. 11 and 12, the beam aberrations, the longitudinal spherical aberration, the astigmatic field curves and the distortion of a third embodiment of the first imaging optical system 6 are represented in the same way as in FIGS. 7 and 8. The aspherical constants for the surfaces 20 and 21 of the third embodiment are indicated in the following Table 7.

TABLE 7

| Surface | c | k | A | B | C | D |
|---|---|---|---|---|---|---|
| 20 | −32.07 | −1.43 | 0 | −0.3030E−8 | 0.1421E−11 | 0 |
| 21 | 38.50 | −2.90 | 0 | 0 | 0 | 0 |

The distances along the optical axis OA of the third embodiment are indicated in the following Table 8.

TABLE 8

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the third embodiment are indicated in the following Table 9:

TABLE 9

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.00927 | 38.115 | −1.20 | −29.6 | −345.8 | 0.18 | −53.1 | 3.21 |

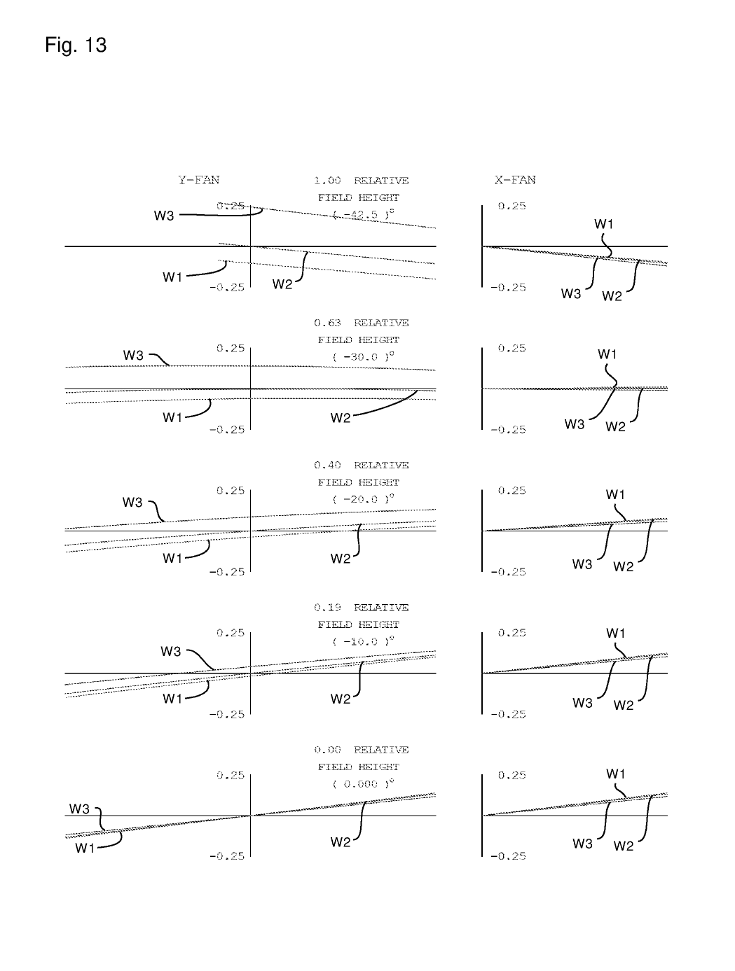

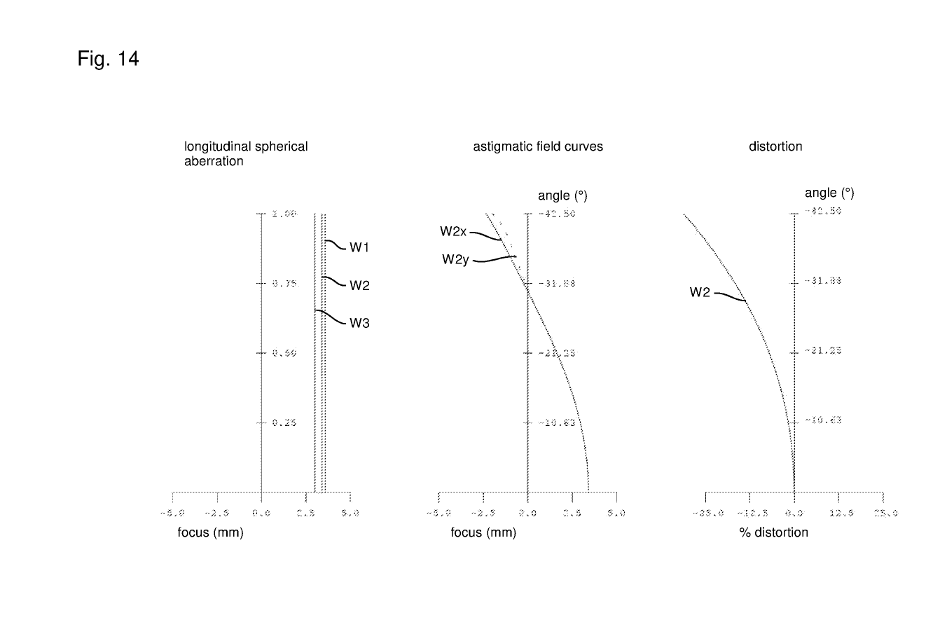

In FIGS. 13 and 14, the beam aberrations, the longitudinal spherical aberration, the astigmatic field curves and the distortion of a fourth embodiment of the first imaging optical system 6 are represented in the same way as in FIGS. 7 and 8. The aspherical constants for the surfaces 20 and 21 for the fourth embodiment are indicated in the following Table 10.

TABLE 10

| Surface | c | k | A | B | C | D |
|---|---|---|---|---|---|---|
| 20 | −35.64 | −0.87 | 0 | −0.3546E−8 | 0.2138E−11 | 0 |
| 21 | 35.67 | −3.41 | 0 | 0 | 0 | 0 |

The distances along the optical axis OA of the fourth embodiment are indicated in the following Table 11.

TABLE 11

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the fourth embodiment are indicated in the following Table 12:

TABLE 12

| | K1 | | K3 | K4 | K5 | K6 | K7 |
|---|---|---|---|---|---|---|---|
| BGL | [mm] | K2 | [%] | [μm] | [mm] | [mm] | [mm] |
| −0.01243 | 38.800 | −1.00 | −31.1 | −346.1 | 0.36 | −54.1 | 3.41 |

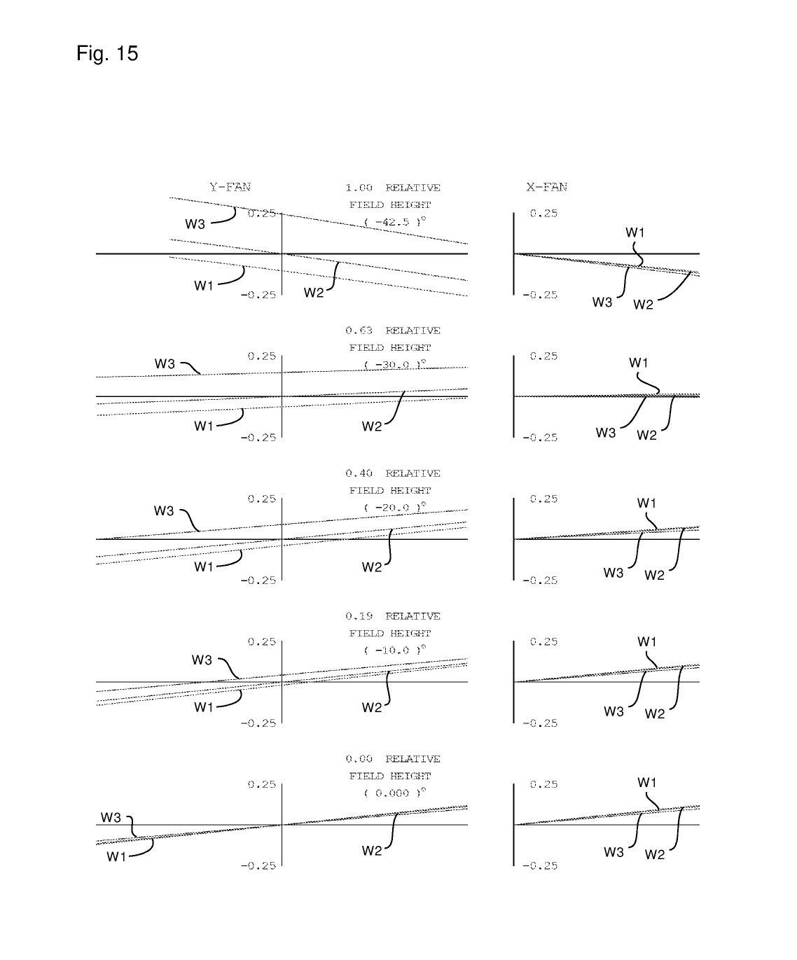

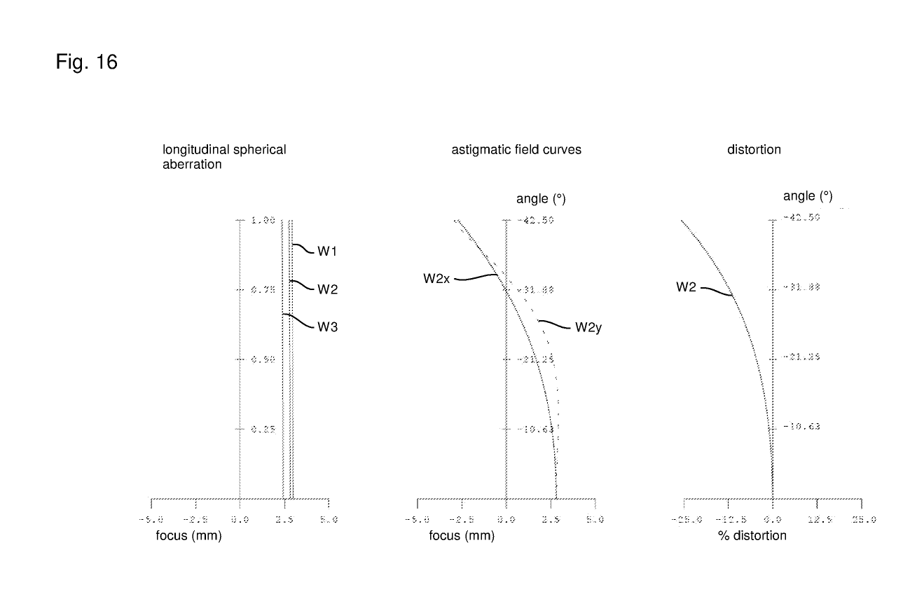

In FIGS. 15 and 16, the beam aberrations, the longitudinal spherical aberration, the astigmatic field curves and the distortion of a fifth embodiment of the first imaging optical system 6 are represented in the same way as in FIGS. 7 and 8. The aspherical constants for the surfaces 20 and 21 of the fifth embodiment are indicated in the following Table 13.

TABLE 13

| Surface | c | k | A | B | C | D |
|---|---|---|---|---|---|---|
| 20 | −26.26 | −1.67 | 0 | −0.1523E−9 | 0.2104E−11 | 0 |
| 21 | 47.26 | −1.19 | 0 | 0 | 0 | 0 |

The distances along the optical axis OA of the fifth embodiment are indicated in the following Table 14.

TABLE 14

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the fifth embodiment are indicated in the following Table 15:

TABLE 15

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.01409 | 36.663 | −1.80 | −25.8 | −347.0 | −0.23 | −51.2 | 2.82 |

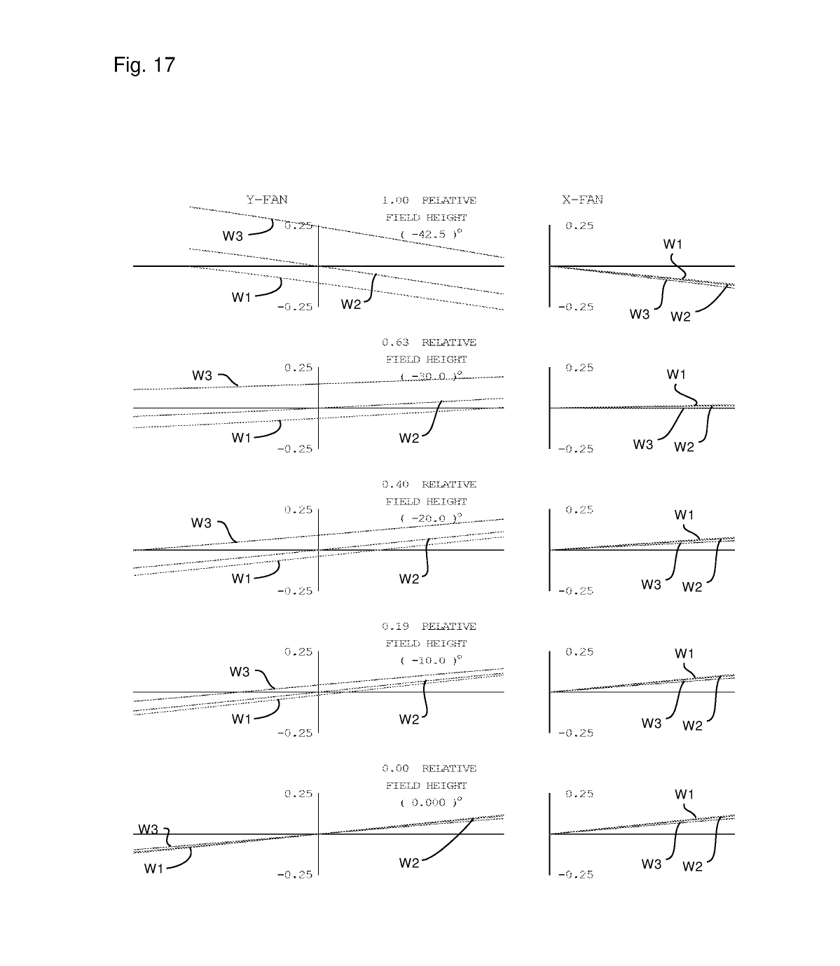

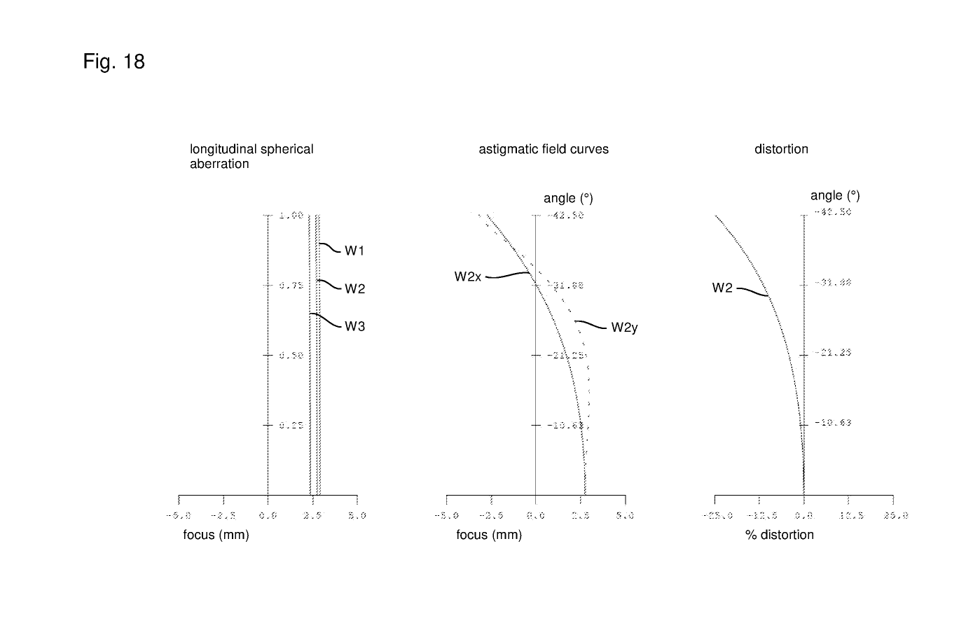

In FIGS. 17 and 18, the beam aberrations, the longitudinal spherical aberration, the astigmatic field curves and the distortion of a sixth embodiment of the first imaging optical system 6 are represented in the same way as in FIGS. 7 and 8. The aspherical constants for the surfaces 20 and 21 of the sixth embodiment are indicated in the following Table 16.

TABLE 16

| Surface | c | k | A | B | C | D |
|---|---|---|---|---|---|---|
| 20 | −25.14 | −1.63 | 0 | −0.5171E−9 | 0.3268E−11 | 0 |
| 21 | 50.27 | −0.47 | 0 | 0 | 0 | 0 |

The distances along the optical axis OA of the sixth embodiment are indicated in the following Table 17.

TABLE 17

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the sixth embodiment are indicated in the following Table 18:

TABLE 18

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.02230 | 36.338 | −2.00 | −24.8 | −347.7 | −0.46 | −50.8 | 2.75 |

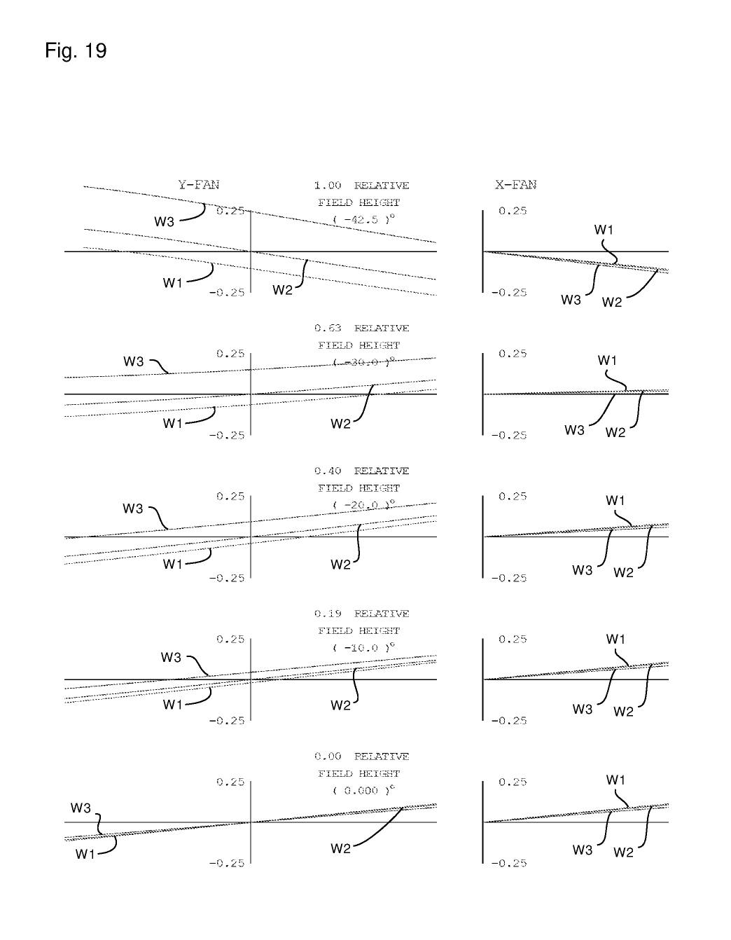

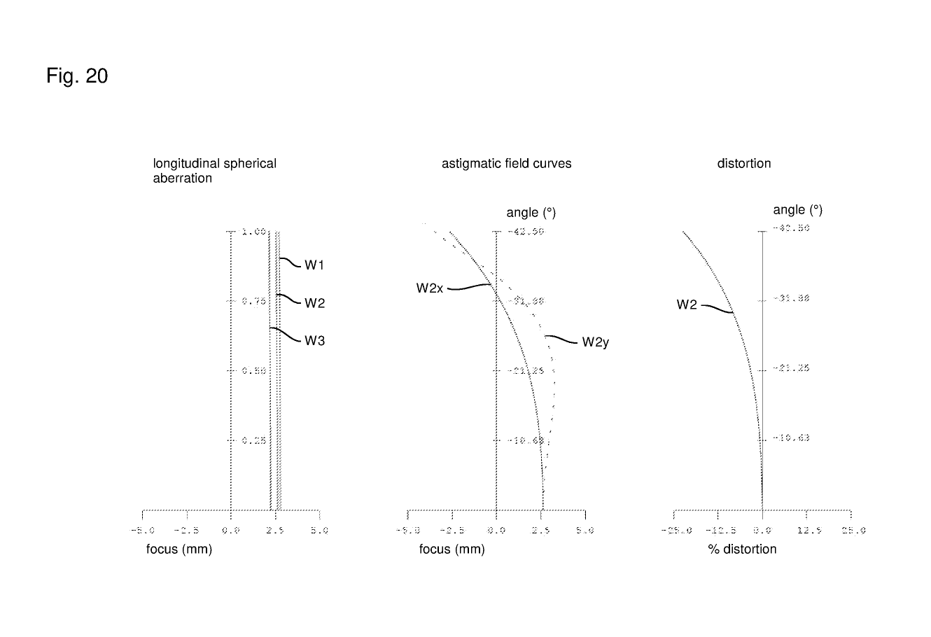

In FIGS. 19 and 20, the beam aberrations, the longitudinal spherical aberration, the astigmatic field curves and the distortion of a seventh embodiment of the first imaging optical system 6 are represented in the same way as in FIGS. 7 and 8. The aspherical constants for the surfaces 20 and 21 of the seventh embodiment are indicated in the following Table 19.

TABLE 19

| Surface | c | k | A | B | C | D |
|---|---|---|---|---|---|---|
| 20 | −23.14 | −1.58 | 0 | −0.8470E−9 | 0.1041E−11 | 0 |
| 21 | 57.86 | 1.47 | 0 | 0 | 0 | 0 |

The distances along the optical axis OA of the seventh embodiment are indicated in the following Table 20.

TABLE 20

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the seventh embodiment are indicated in the following Table 21:

TABLE 21

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.04740 | 35.685 | −2.50 | −22.5 | −349.9 | −0.82 | −50.2 | 2.62 |

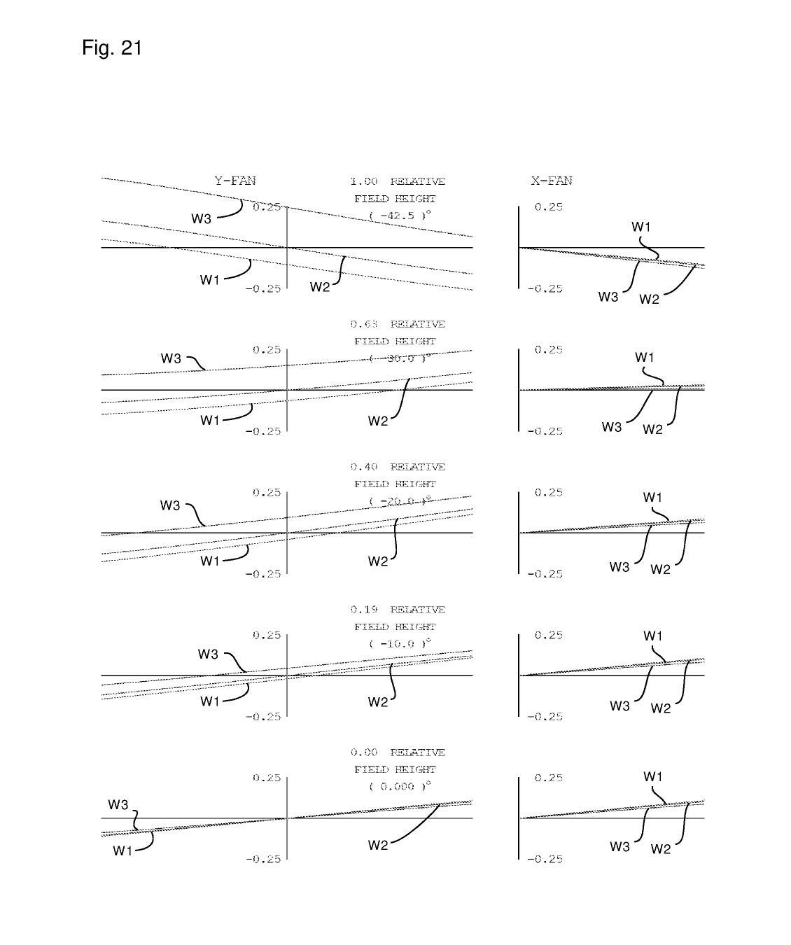

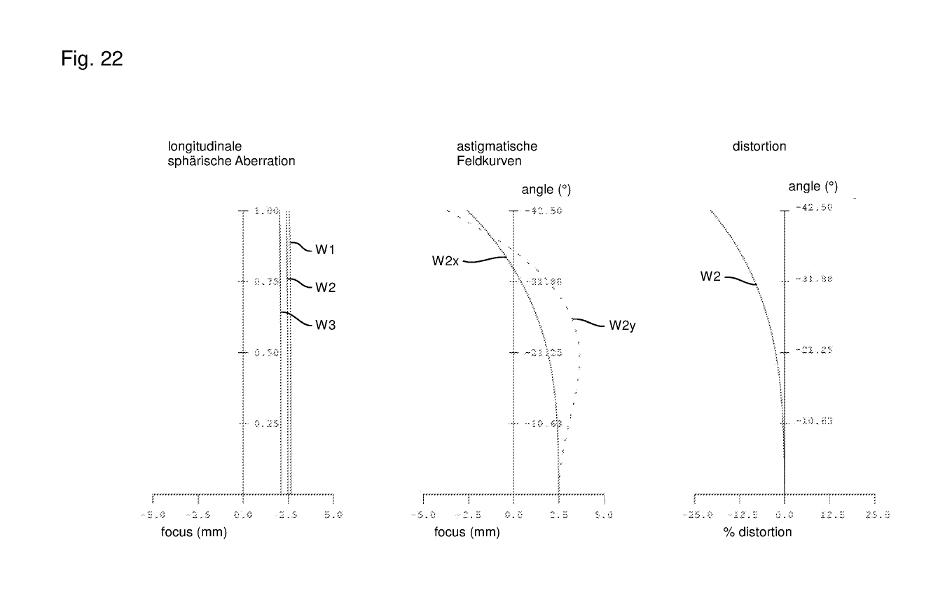

In FIGS. 21 and 22, the beam aberrations, the longitudinal spherical aberration, the astigmatic field curves and the distortion of an eighth embodiment of the first imaging optical system 6 are represented in the same way as in FIGS. 7 and 8. The aspherical constants for the surfaces 20 and 21 of the eighth embodiment are indicated in the following Table 22.

TABLE 22

| Surface | c | k | A | B | C | D |
|---|---|---|---|---|---|---|
| 20 | −21.82 | −1.60 | 0 | −0.6003E−8 | 0.2321E−10 | 0 |
| 21 | 65.45 | 3.90 | 0 | 0 | 0 | 0 |

The distances along the optical axis OA of the eighth embodiment are indicated in the following Table 23.

TABLE 23

| Surface-Surface | Distance [mm] |
|---|---|
| 22-21 | 16.0 |
| 21-20 | 14.2 |
| 20-19 | 29 |
| 19-E | 0.8 |

The value for BGL as well as for further parameters characterizing the first imaging optical system 6 according to the eighth embodiment are indicated in the following Table 24:

TABLE 24

| | K1 | | K3 | K4 | K5 | K6 | K7 |
|---|---|---|---|---|---|---|---|
| BGL | [mm] | K2 | [%] | [μm] | [mm] | [mm] | [mm] |
| 0.06873 | 35.166 | −3.00 | −20.5 | −351.9 | −1.11 | −49.6 | 2.49 |

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-12. (canceled)

13. A display device, comprising:
a holder that can be fitted on the head of a user; and
a first imaging optical system secured to the holder, which is configured to image an image generated in an image plane as a virtual image such that, when the holder is fitted on the head of the user, the user can perceive the virtual image with a first eye,
wherein the first imaging optical system comprises, as imaging element, precisely one first lens with a first and a second boundary surface, wherein the two boundary surfaces are each aspherically curved.

14. The display device according to claim 13, wherein the first boundary surface faces the image plane and the ratio of the value of a vertex curvature of the first boundary surface to the value of a vertex curvature of the second boundary surface is in the range of 1.2 to 1.8.

15. The display device according to claim 14, wherein the second boundary surface is a hyperboloid without higher-order deformations.

16. The display device according to claim 15, wherein the first boundary surface is a hyperboloid with higher-order deformations.

17. The display device according to claim 14, wherein the first boundary surface is a hyperboloid with higher-order deformations.

18. The display device according to claim 13, wherein the second boundary surface is a hyperboloid without higher-order deformations.

19. The display device according to claim 18, wherein the first boundary surface is a hyperboloid with higher-order deformations.

20. The display device according to claim 13, wherein the first boundary surface is a hyperboloid with higher-order deformations.

21. The display device according to claim 13, wherein the first imaging optical system is free from deflecting elements for beam path folding.

22. The display device according to claim 13, wherein, when the holder is fitted on the head of the user, the image plane is essentially perpendicular to a direction of forward view of the user.

23. The display device according to claim 13, wherein the first lens is formed of a plastic material.

24. The display device according to claim 13, wherein the first imaging optical system comprises an exit pupil, wherein the distance between the exit pupil and the image plane is in a range of 50 mm to 70 mm.

25. The display device according to claim 13, wherein the first imaging optical system comprises an exit pupil having a maximum dilatation of at least 3 mm.

26. The display device according to claim 25, wherein the first imaging optical system comprises an exit pupil having a maximum dilatation of at least 5 mm.

27. The display device according to claim 13, wherein, for the first imaging optical system, |nₐᵢᵣ*sin β₁−n_{substrate}*sin β₂+nₐᵢᵣ*sin β₃−n_{substrate}*sin β₂| is almost zero, wherein β₁ is the angle following an exit pupil, β₂ is the angle following the first boundary surface and β₃ is the angle following the second boundary surface of a main beam H1 at the edge of the field to be imaged with an axis shifted in parallel with respect to the optical axis, and nₐᵢᵣ and n_{substrate} are the indices of refraction of a surrounding medium in each case.

28. The display device according to claim 13, wherein, in the image plane, an imaging system is arranged, which generates the image which is imaged by the first imaging optical system.

29. The display device according to claim 28, wherein the imaging system is replaceably arranged in the image plane.
